(19) United States
(12) Patent Application Publication
(10) Pub. No.: US 2012/0139303 A1
(43) Pub. Date: Jun. 7, 2012

(54) DISPLAY ASSEMBLY

(76) Inventors: RIK WESTERINK, Corinth, TX (US); Timothy W. Terleski, Richardson, TX (US); Per Magnus Skold, McKinney, TX (US); Alexander Gerard Saucier, Addison, TX (US); Armando Valdes, Denton, TX (US)

(21) Appl. No.: 13/311,041

(22) Filed: Dec. 5, 2011

Related U.S. Application Data
(60) Provisional application No. 61/459,173, filed on Dec. 7, 2010.

(51) Int. Cl. B64D 11/06

(52) U.S. Cl. 297/163; 297/188.04

(57) ABSTRACT

Described are display assemblies having a display coupled to a passenger seat back, a shroud coupled to the passenger seat back with an inner opening positioned adjacent the display, and a cradle coupled to a lower edge of the shroud and positioned below the shroud adjacent a stowage location of a tray table, wherein the cradle includes an electronics apparatus connected to the display. The display assembly may also include a tray table with a recess, wherein the cradle is configured to stow at least partially within the recess when the tray table is positioned in the stowage location.

### CROSS REFERENCE TO RELATED APPLICATION

This application is related to and claims priority benefits from U.S. Provisional Application Serial No. 61/459,173, filed on Dec. 7, 2010, entitled INSTALLATION OF ELECTRONIC DEVICES BEHIND FOOD TABLE. The '173 application is hereby incorporated herein in its entirety by this reference.

### FIELD OF THE INVENTION

The invention relates to passenger seats or the like.

### BACKGROUND

Many passenger seats such as those on passenger aircraft, buses, trains, and the like are arranged so that each passenger seat, other than the forward-most located passenger seats, faces the back of the next forward passenger seat. To increase a passenger's comfort and enjoyment, many passenger seat backs are utilized to install amenities for the passenger's use during the trip. For example, as shown in FIG. 1, an upper surface of the seat back may be used to install In-Flight Entertainment (“IFE”) equipment or other entertainment devices, such as displays, passenger control units, and game controllers.

In many situations, the size of the displays have grown increasingly larger to enhance the entertainment experience of the passenger. Because the space on the seat back is limited, it may be desirable to provide alternative locations to install other electronic components of the IFE system.

### SUMMARY

Embodiments of the present invention include a display assembly comprising a display coupled to a passenger seat back, a shroud coupled to the passenger seat back and comprising an inner opening positioned adjacent the display, and a cradle coupled to a lower edge of the shroud and positioned below the shroud adjacent a stowage location of a tray table, wherein the cradle comprises an electronics apparatus connected to the display. Other embodiments may further include a passenger seat comprising the passenger seat back. In some embodiments, the display assembly may further comprise a pocket coupled to the passenger seat back.

The cradle and the shroud may be formed of the same materials or different materials, or the cradle may be integrally formed with the shroud. In other embodiments, the display may be an in-flight entertainment display.

According to certain embodiments, an assembly may comprise a shroud coupled to the passenger seat back, a cradle coupled to a lower edge of the shroud, wherein the cradle comprises an electronics apparatus connected to the display, and a tray table comprising a recess, wherein the cradle is positioned below the shroud adjacent a stowage location of the tray table and configured to stow at least partially within the recess when the tray table is positioned in the stowage location.

### BRIEF DESCRIPTION OF THE DRAWINGS

FIG. 1 is a perspective view of a prior art display assembly.

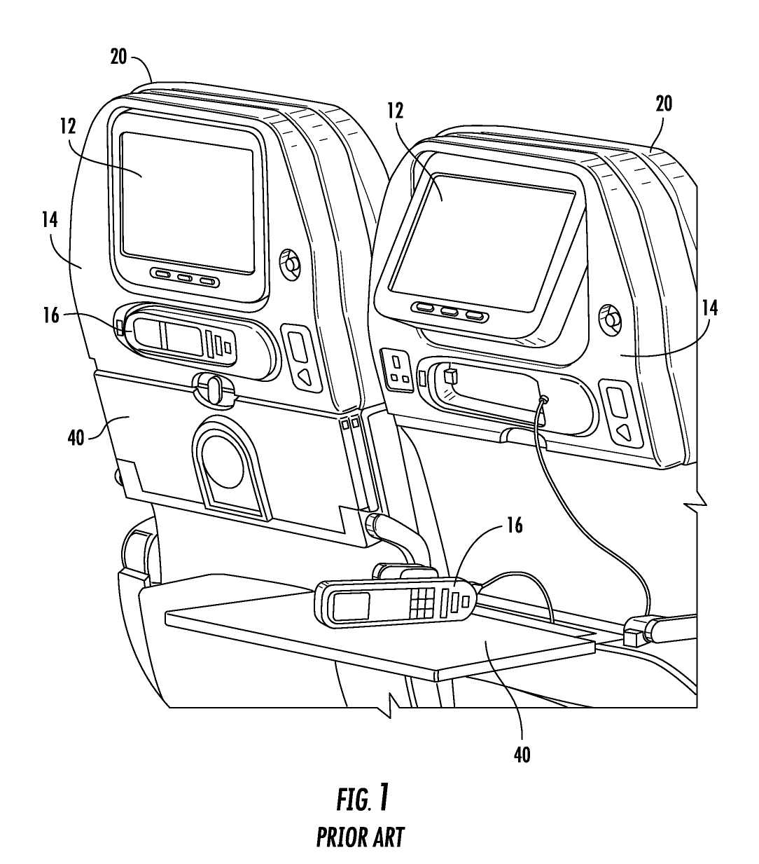

FIG. 2 is a front view of a display assembly according to certain embodiments of the present invention.

FIG. 3 is a perspective view of the display assembly of FIG. 2.

### DETAILED DESCRIPTION

The described embodiments of the invention provide display assemblies for use with passenger seats. While the display assemblies are discussed for use with aircraft seats, they are by no means so limited. Rather, embodiments of the display assemblies may be used in passenger seats or other seats of any type or otherwise as desired.

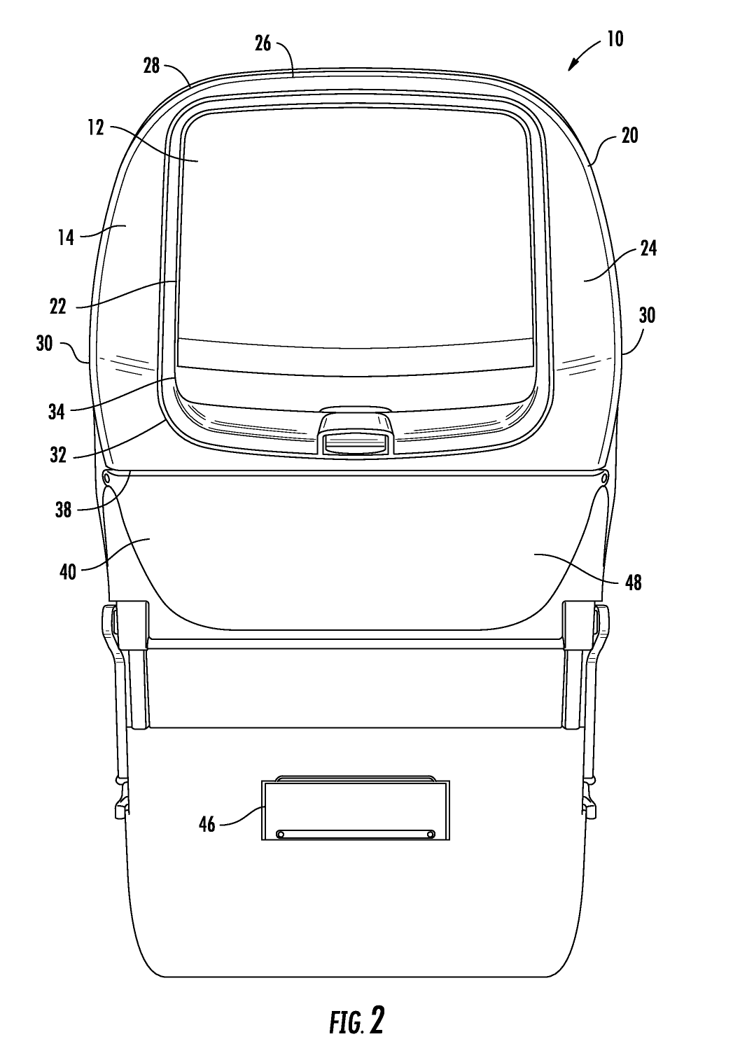

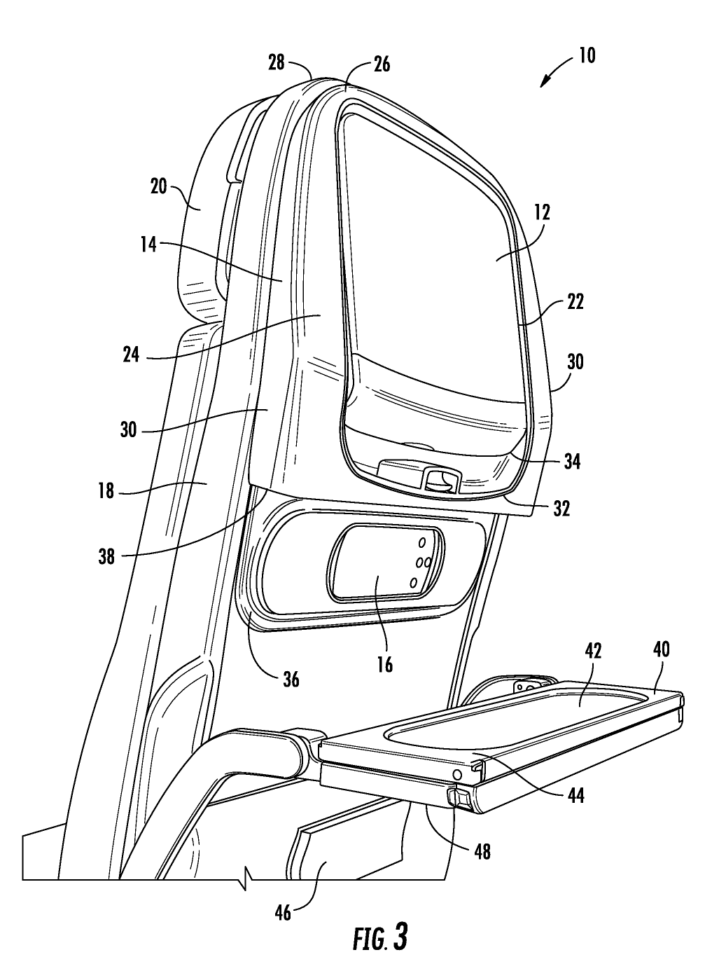

FIGS. 2-3 illustrate embodiments of a display assembly 10. In these embodiments, the display assembly 10 comprises a display 12, a shroud 14, and an electronics apparatus 16. The electronics apparatus 16 may include passenger control units, IFE controllers, game controllers, or any other kind of portable electronic device.

The display 12 may be a display for an IFE or other entertainment devices. In some embodiments, the display 12 is coupled to a back 18 of a passenger seat 20. One of ordinary skill in the relevant art will understand that any suitable coupling technique may be used to attach the display 12 to the back 18 including but not limited to mechanical fasteners such as screws, bolts, rivets, compression fit, or other suitable fasteners.

The display 12 may comprise any suitable outer perimeter shape 22 including but not limited to square, rectilinear, trapezoidal, parabolic, or other suitable shape that does not exceed an outer perimeter 28 of the back 18. In certain embodiments, the back 18 may include a recess that is shaped to accommodate the outer perimeter shape 22 of the display 12 and at least a portion of a depth of the display 12.

As shown in FIGS. 2-3, embodiments of the shroud 14 may be coupled to the back 18. One of ordinary skill in the relevant art will understand that any suitable coupling technique may be used to attach the shroud 14 to the back 18 including but not limited to mechanical fasteners such as screws, bolts, rivets, compression fit, or other suitable fasteners. The shroud 14 may include a surface 24 having a outer shape 26 that conforms to at least a portion of the outer perimeter 28 of the back 18. The shroud 14 includes sides 30 that are shaped so that the surface 24 of the shroud 14 is positioned adjacent and/or aft of the display 12.

The shroud 14 may be formed of a material that resists stains and is easily and quickly sanitized between passenger uses including but not limited to plastics, such as polycarbonate, polyethylene, polypropylene, polyvinyl chloride, or other similar plastics, metallic materials, composite materials, or other similar materials.

The shroud 14 may also comprise an inner opening 32. The inner opening 32 may be shaped so that the display 12 is visible through the shroud 14. Thus, the inner opening 32 may have any suitable shape that substantially surrounds at least an outer edge 34 of the display 12.

A cradle 36 to house the electronics apparatus 16 may be coupled to a lower edge 38 of the shroud 14. In some embodiments, the electronics apparatus 16 is coupled to the cradle 36 in a deployable manner that allows the electronics apparatus 16 to be removed from the cradle 36 for use by a passenger and stowed within the cradle 36 when no longer in use. For example, the cradle 36 may include spring-loaded tabs or types of pressure fittings that hold the electronics apparatus 16 within the cradle 36 until the passenger releases the electronics apparatus 16 from the cradle 36. In these embodiments, the electronics apparatus 16 may be hard wired or wirelessly connected to the display 12 and/or the IFE system and/or other system within the aircraft or vehicle.

The electronics apparatus 16 may also be configured so that a passenger may use the electronics apparatus 16 while it is positioned within the cradle 36. In these embodiments, the electronics apparatus 16 may also be deployable from the cradle 36 as described above or may be mounted to the cradle 36 via fasteners that prevent its removal from the cradle 36 by a passenger.

The cradle 36 may be formed of any suitable material including but not limited to plastics, such as polycarbonate, polyethylene, polypropylene, polyvinyl chloride, or other similar plastics, metallic materials, composite materials, or other similar materials. In some embodiments, the cradle 36 and the shroud 14 may be formed of substantially the same or similar materials. In other embodiments, the cradle 36 and the shroud 14 may be formed of different materials. For example, in some embodiments, the shroud 14 may be formed of a more durable material, while the cradle 36 may be formed of a less expensive material or a thinner version of the shroud 14 material in cases where the cradle 36 is configured as a disposable or wear part. One of ordinary skill in the relevant art will understand that any suitable combination of materials may be used to form the shroud 14 and the cradle 36.

In some embodiments, the cradle 36 may be integrally formed with the shroud 14 or may be coupled to the shroud 14 via any suitable mechanical or chemical fasteners including but not limited to screws, bolts, rivets, compression fit, adhesives, or other suitable fasteners. In these embodiments, the electronics apparatus 16 and/or cradle 36 may be replaced, retrofitted onto an existing shroud 14, or removed without the need to modify or replace the display 12 and/or the shroud 14.

The cradle 36 may be positioned adjacent a region of the back 18 that functions as a stowage location of a tray table 40 (as shown in FIG. 2). In these embodiments, a recess 42 may be formed in a surface 44 of the tray table 40 (as shown in FIG. 3) that is shaped to that the cradle 36 will stow at least partially within the recess 42 so that the stowage location of the tray table 40 is not substantially altered. In other embodiments, a recess 42 may not be required in order for the stowage location of the tray table 40 to remain substantially unaltered.

As a result, the location of the electronics apparatus 16 forward of the stowage location of the tray table 40 provides an uncluttered appearance to the display 12 and the shroud 14 because the electronics apparatus 16 is hidden from view when the tray table 40 is stowed. Furthermore, positioning the electronics apparatus 16 forward of the stowage location of the tray table 40 provides additional space within the back 18 that may be used to mount larger displays 12 or other amenities, such as a cup holder, a spectacle holder, an amenity pocket, or other suitable item.

In these embodiments, locating the electronics apparatus 16 forward of the stowage location of the tray table 40 may also lower the risk of injury during a crash event. In other embodiments, the cradle 36 and the electronics apparatus 16 may be located behind the stowed position of the tray table 40 even when the display 12 is not present.

The location of the electronics apparatus 16 forward of the stowage location of the tray table 40 does not intrude on the amount of living space available to a passenger seated aft of the passenger seat 20. Furthermore, positioning the electronics apparatus 16 adjacent the display 12, as opposed to armrests of the passenger seat 20 simplifies the cable installation.

In certain embodiments, a pocket 46 may be positioned on the back 18 of the passenger seat 20 for temporary storage of the electronics apparatus 16 when the tray table 40 is stowed. The pocket 46 may be positioned in any suitable location including but not limited to the back 18 below the tray table 40, a back surface 48 of the tray table 40, or a literature pocket. In other embodiments, a hook may be used in place of the pocket 46.

The foregoing is provided for purposes of illustrating, explaining, and describing embodiments of the present invention. Further modifications and adaptations to these embodiments will be apparent to those skilled in the art and may be made without departing from the scope or spirit of the invention.

That which is claimed is:

1. A display assembly comprising:
(a) a display coupled to a passenger seat back;
(b) a shroud coupled to the passenger seat back and comprising an inner opening positioned adjacent the display; and
(c) a cradle coupled to a lower edge of the shroud and positioned below the shroud adjacent a stowage location of a tray table, wherein the cradle comprises an electronics apparatus connected to the display.

2. The display assembly of claim 1, further comprising a pocket coupled to the passenger seat back.

3. The display assembly of claim 1, wherein the cradle and the shroud are formed of the same materials.

4. The display assembly of claim 1, wherein the cradle and the shroud are formed of different materials.

5. The display assembly of claim 1, wherein the cradle is integrally formed with the shroud.

6. The display assembly of claim 1, wherein the display is an in-flight entertainment display.

7. A passenger seat comprising:
(a) a passenger seat back; and
(b) a display assembly comprising:
(i) a display coupled to the passenger seat back;
(ii) a shroud coupled to the passenger seat back and comprising an inner opening positioned adjacent the display; and
(iii) a cradle coupled to a lower edge of the shroud and positioned below the shroud adjacent a stowage location of a tray table, wherein the cradle comprises an electronics apparatus connected to the display.

8. The passenger seat of claim 7, further comprising a pocket coupled to the passenger seat back.

9. The passenger seat of claim 7, wherein the cradle and the shroud are formed of the same materials.

10. The passenger seat of claim 7, wherein the cradle and the shroud are formed of different materials.

11. The passenger seat of claim 7, wherein the cradle is integrally formed with the shroud.

12. The passenger seat of claim 7, wherein the display is an in-flight entertainment display.

13. An assembly comprising:
(a) a shroud coupled to a passenger seat back;
(b) a cradle coupled to a lower edge of the shroud, wherein the cradle comprises an electronics apparatus; and
(c) a tray table comprising a recess, wherein the cradle is positioned below the shroud adjacent a stowage location of the tray table and configured to stow at least partially within the recess when the tray table is positioned in the stowage location.

14. The assembly of claim 13, further comprising a pocket coupled to the passenger seat back.

15. The assembly of claim 13, wherein the cradle and the shroud are formed of the same materials.

16. The assembly of claim 13, wherein the cradle and the shroud are formed of different materials.

17. The assembly of claim 13, wherein the cradle is integrally formed with the shroud.

18. The assembly of claim 13, further comprising a display coupled to the passenger seat back.

19. The assembly of claim 18, wherein the shroud comprises an inner opening positioned adjacent the display.

20. The assembly of claim 18, wherein the display is an in-flight entertainment display.
